(19) United States
(12) Patent Application Publication
(10) Pub. No.: US 2022/0219166 A1
(43) Pub. Date: Jul. 14, 2022

(54) Blot Printer Chip

(71) Applicant: LI-COR, Inc., Lincoln, NE (US)

(72) Inventors: Michael D. Furtaw, Lincoln, NE (US); Donald T. Lamb, Lincoln, NE (US)

(73) Assignee: LI-COR, Inc., Lincoln, NE (US)

(21) Appl. No.: 17/575,275

(22) Filed: Jan. 13, 2022

Related U.S. Application Data
(60) Provisional application No. 63/137,633, filed on Jan. 14, 2021.

(51) Int. Cl. B01L 3/00; G01N 27/447

(52) U.S. Cl. CPC B01L 3/502715; B01L 3/567; G01N 27/44739; G01N 27/44791; B01L 2400/0406; B01L 2300/12; B01L 2300/0645; B01L 2400/0622; B01L 2200/10; B01L 2400/0439

(57) ABSTRACT

A multilayered microfluidic chip integrating separation channels and a common piezoelectric pump dispensing to a blotting membrane is described. A top layer with separation channels is connected with vias through a middle layer to a nozzle area in a bottom layer that has a piezoelectric pump. Because each via is very near a separate orifice in the bottom layer, the buffer fluid in the bottom layer will quickly dispense analyte emerging from the via. The analyte is pumped out of the orifice carried by the buffer fluid. A common reservoir of buffer fluid, connected with the pump membrane, is used. Electrodes may be placed near the entrance of each separation channel and share a terminating electrode in the common reservoir.

### CROSS-REFERENCES TO RELATED APPLICATIONS

This application claims the benefit of U.S. Provisional Patent Application No. 63/137,633, filed Jan. 14, 2021, which is hereby incorporated by reference in its entirety for all purposes.

### STATEMENT AS TO RIGHTS TO INVENTIONS MADE UNDER FEDERALLY SPONSORED RESEARCH AND DEVELOPMENT

This invention was made with government support under GM112289 awarded by The National Institutes of Health. The government has certain rights in the invention.

### BACKGROUND

### 1. Field of the Invention

The present application generally relates to lab-on-a-chip microfluidic devices having integrated separation channels and a shared, piezoelectric diaphragm pump for dispensing analytes to a membrane. Specifically, the application is related to devices, manufacturing methods, and methods of use for a microfluidic device that uses a layered design in order to place separated analytes from multiple channels in one layer into sheath fluid immediately in front of inkjet-like orifices in another layer that has a common piezoelectric ejection actuator, among other configurations.

### 2. Description of the Related Art

Western blotting is a ubiquitous technique in molecular biology labs around the world. While the imaging and detection portions have greatly improved over time, the separation and blotting components remain much like they were originally invented.

Capillary electrophoresis provides an alternative to the gel electrophoresis separation associated with western blotting and other biotechnology procedures. In capillary electrophoresis, materials such as proteins are separated electrokinetically, as in gel electrophoresis, but with much smaller required volumes. The capillaries used in this technique are typified by diameters smaller than one millimeter and are in some instances incorporated into microfluidic or nanofluidic devices.

Previous work has demonstrated the benefits of applying microfluidic devices to Western blotting of proteins (Jin et al. 2013 Anal. Chem. 85:6073). These devices electrically transfer separated proteins to a blotting surface that is itself the terminating electrode. (See, e.g., U.S. Pat. No. 9,182,371). This electrical field blotting approach requires continuous electrical contact from a separation device to the surface. As a result, the surface must be electrically conductive (e.g., a wet membrane on metal platen).

Alternative dispensing techniques such as, for example, inkjetting of material, can address some of the above issues. Inkjet dispensing of homogeneous, bulk inks is a mature and well-understood technology that is employed in commercial printers (Martin et al. 2008 J. Physics: Conference Series 105:012001). Over the past several years, inkjet technology has been used in an increasing variety of applications where the dispensing of small, controllable amounts of fluid is required (Derby 2010 Ann. Rev. Mat. Res. 40:395). Yet piezoelectric, drop-on-demand inkjet actuators used in analytical instrumentation are expensive as each one requires drive electronics and an accurately placed piezo actuator.

There is a need in the art for inexpensive and more accurate blotting techniques for separated analytes for molecular biology applications.

### BRIEF SUMMARY

A lab-on-a-chip is fabricated such that it can inkjet the output from tens or hundreds of separation channels from one common piezoelectric bar actuator. The lab-on-a-chip has multiple layers. One layer forms the separation microchannels. Another (bottom) layer houses a flat, wide pump chamber over which the piezoelectric bar is mounted so that it displaces a thin wall close to nozzles for each respective separation microchannel. A layer sandwiched in between the other layers positions a small feedthrough hole at the end of each separation microchannel and near the nozzle. The analyte(s) from the separation channels electromigrate through the small feedthrough holes to positions right in front of the respective nozzles.

When the piezoelectric bar actuates and displaces the thin wall, an acoustic wave travels through buffer fluid in the pump chamber to the nozzles and pushes a tiny (nano-, picoliter) bit of buffer fluid, containing analyte(s), out the nearby nozzles in the form of discrete droplets.

At the entrance to each separation channel can be a through hole through the entire microfluidic chip. Cleaning, diluting, buffer fluid is introduced on one side of the through hole to wash out the entrance. Once complete, the fluid is sucked away or allowed to flow from the other side of the through hole.

Some embodiments of the present invention are related to a microfluidic chip-based separation column and inkjet blotter apparatus including a top layer having multiple separation channels etched therein, each separation channel having an inlet end, an outlet end, and a port hole extending from the inlet end to an external face of the top layer, a middle layer intimately disposed on the top layer, the middle layer having feedthrough holes, each feedthrough hole positioned at the outlet end of a corresponding separation channel, a pump layer sandwiching the middle layer between the pump layer and the top layer, the pump (bottom) layer having a chamber etched therein with nozzles on one side, each nozzle aligned with one of the feedthrough holes, the chamber sided by an inkjet diaphragm defined by a wall thickness between an external face of the pump layer and an internal surface of the chamber, and a piezoelectric actuator bar bonded to the inkjet diaphragm, wherein the piezoelectric actuator bar spans across the multiple separation channels.

Each separation channel port hole can extend all the way through the top, middle, and pump layers. There can be a purge valve connected with the at least one port hole. There can be a cupped volume on the external face around at least one of the port holes.

The apparatus can include a machined orifice plate having the nozzles.

The top layer or the pump layer can have a conduit etched therein that extends from a conduit port hole to the chamber, the conduit able to transport buffer liquid to the chamber. There can be metal pads on the inkjet diaphragm, such that the piezoelectric actuator bar is bonded to the inkjet diaphragm through solder to the metal pads.

The top layer and the pump layer can be glass, quartz, or silicon, and the middle layer can be glass and quartz, silicon or polyimide. There can be a plastic caddy enveloping a portion of the top, middle, or pump layers. The port holes can be spaced apart 1.0 millimeter (mm), 2.0 mm, 2.25 mm, 4.5 mm, or 9.0 mm. Each separation channel can have a straight section that is 20 millimeters (mm) to 100 mm long and a cross section of 500 square microns (μm²) to 5000 μm². The inkjet diaphragm wall thickness can be less than 500 microns (μm), or preferably between 250 μm and 300 μm.

The middle layer can have a thickness between 1 μm and 300 microns (μm). The apparatus can include an electrode at the inlet end of each separation channel, and an electrode in the pump chamber. The apparatus can include a blotting membrane support and a motor configured to move the blotting membrane support relative to the nozzles.

Some embodiments are related to a purgeable microfluidic chip-based separation column apparatus including a top layer having multiple separation channels etched therein, each separation channel having an inlet end, an outlet end, and a port hole extending from the inlet end to an external face of the top layer, a middle layer intimately disposed on the top layer, the middle layer having feedthrough holes, each feedthrough hole positioned at the outlet end of a corresponding separation channel, a pump layer sandwiching the middle layer between the pump layer and the top layer, the pump layer having a chamber etched therein with nozzles on one side, each nozzle aligned with one of the feedthrough holes, the chamber sided by an inkjet diaphragm defined by a wall thickness between an external face of the pump layer and an internal surface of the chamber, and a piezoelectric actuator bar bonded to the inkjet diaphragm, in which each separation channel port hole extends all the way through the top, middle, and pump layers.

The apparatus can include a purge valve connected with the at least one port hole. It can include a cupped volume on the external face around at least one of the port holes. It can include a machined orifice plate having the nozzles.

### BRIEF DESCRIPTION OF THE DRAWINGS

FIG. 1A is a perspective view of the top of a blot printer chip in accordance with an embodiment.

FIG. 1B is a perspective view of the bottom of the device in FIG. 1A.

FIG. 2 is a not-to-scale cross section through the device of FIG. 1A.

FIG. 3 is a plan view of a top layer of the device of FIG. 1A.

FIG. 4 is a plan view of a middle layer of the device of FIG. 1A.

FIG. 5 is a plan view of a bottom layer of the device of FIG. 1A.

FIG. 6 is a perspective view of a blot printer chip that is being cleaned and prepared in accordance with an embodiment.

FIG. 7A is a cross section of a blot printer chip into which cleaning fluid is introduced in accordance with an embodiment.

FIG. 7B illustrates the cleaning fluid flowing after FIG. 7A.

FIG. 7C illustrates the cleaning fluid evacuating from the blot printer chip after FIG. 7B.

FIG. 8 illustrates a pressurized manifold for cleaning fluid in accordance with an embodiment.

FIG. 9 illustrates a cross section of layers similar to that in FIGS. 3-5 in accordance with an embodiment.

FIG. 10 illustrates a cross section of layers with a dug out pump chamber in a bottom layer in accordance with an embodiment.

FIG. 11 illustrates a cross section of layers with a cap layer in accordance with an embodiment.

FIG. 12 illustrates a cross section of layers with a thick top layer and middle layer pump chamber in accordance with an embodiment.

FIG. 13 illustrates a cross section of layers with separation and pump chamber volumes etched in a middle substrate in accordance with an embodiment.

FIG. 14 illustrates a cross section of layers with a cap layer and a dug out pump chamber in a bottom layer in accordance with an embodiment.

FIG. 15 illustrates a caddied blot printer chip held over a moving blotting membrane in accordance with an embodiment.

### DETAILED DESCRIPTION

A “blot printer chip” (BPC) is a microfluidic device that enables the throughput of multi-capillary electrophoresis with inkjet dispensing without the difficulty of working with multiple, individual capillaries of the prior art. By contrast, using multiple, individual capillaries may involve making individual connections for the inlet and outlet of each capillary, which takes time and expense. They also limit the compactness of a solution due to the finite size of the connectors, and they increase the probability of leaks.

A technical advantage of a microfluidic chip can be the ability to increase throughput via parallelization. A desired final product may have several, if not dozens, hundreds, or thousands, of separation channels. The inkjet portion of the chip can be capable of dispensing samples through many orifices in parallel using a single piezoelectric actuator. One of the only substantial limitations on number of sample channels is complexity, in that more orifices may lead to more problems.

Some embodiments discussed herein use a simple configuration where each separation channel has only one inlet and one outlet. Each outlet is in close proximity to an orifice (one orifice per separation channel). The orifices each dispense fluid in the form of discrete drops, like droplet-on-demand inkjet printing, using a single piezoelectric actuator for the array of channels.

This is as compared with that in U.S. Patent Application Publication No. US 2018/0036729 A1 titled “Microchip electrophoresis inkjet dispensing,” which may require a dedicated actuator for each channel. In present embodiments, a single piezoelectric actuator can enable many, many separations to occur simultaneously while printing the separated analytes in individual locations on a moving membrane or an alternative collection substrate without much cost.

A microfluidic lab-on-a-chip can be a central component of the described system. Multiple samples can be loaded, separated, and inkjet dispensed all from a single chip. One advantage of using a microfluidic chip in this case is to alleviate some complications of using multiple capillaries in parallel. The chip can include several, individual channels that are used much like a capillary with no intersecting additional channels for certain applications. The only intersection occurs where each separation channel terminates into the inkjet dispenser/pump chamber. As the analytes exit each separation channel, they are dispensed out of the chip, as quickly as possible to prevent separation loss, without cross-contamination.

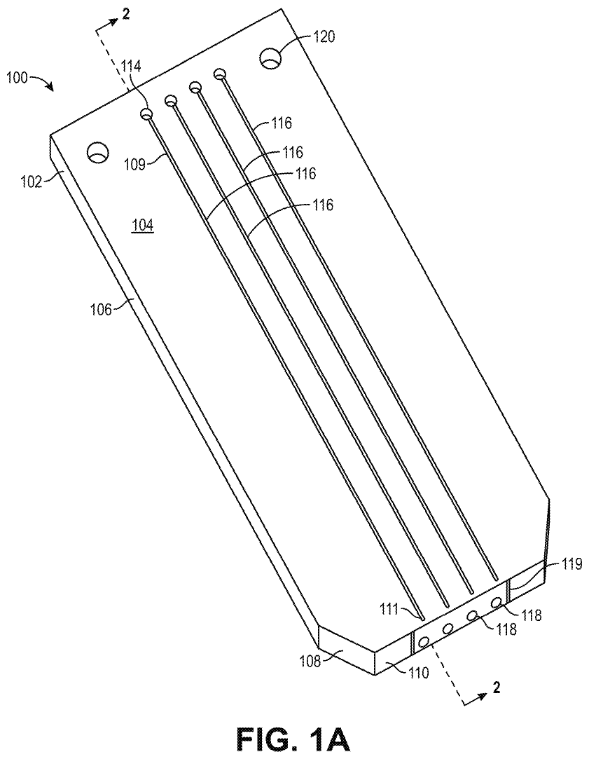

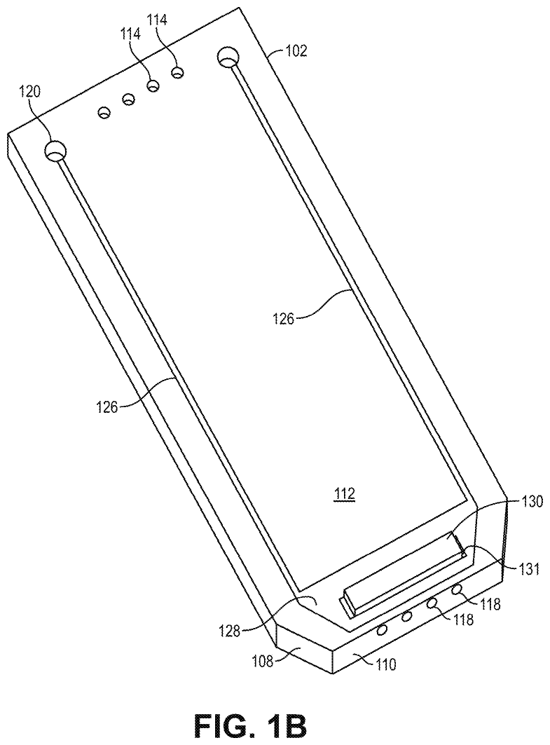

FIGS. 1A-1B are perspective views of the top and bottom of blot printer chip system 100.

Exemplary blot printer chip 102 includes four straight separation channels 116, which are capillary sized, each having inlet end 109 and outlet end 111. Separation channels 116 are not on the external surface but just underneath and visible in the figure through the transparent glass material of the top layer. At inlet end 109, port hole 114 extends through the top layer from external, top face 104 of the blot printer chip to external, bottom face 112 (see FIG. 1B).

In the exemplary embodiment, separation channels 116 are about 10 cm long. In some embodiments, separation channels can have a straight section that is 20 mm to 100 mm long, or longer and shorter as required. Their cross-section area is equivalent to a 50 μm diameter circle, with a low aspect ratio that minimizes surface area to volume, such as a 90 μm×25 μm D-shaped channel. Cross sections can vary between 500 μm² to 5000 μm², or smaller or larger.

The port holes and separation channels can be spaced apart 1.0 mm, 2.0 mm, 2.25 mm, 4.5 mm, 9.0 mm, or other distances.

The inkjet functionality can require a nozzle orifice for each separation channel. The orifice cross section can be a variety of shapes. The orifices should be, but are not required to be, symmetric about at least one axis. The optimal shape can be a circle. Other shapes that have been used successfully are triangles, squares, and low-aspect ratio ellipses.

The blot printer chip includes side face 106, diagonal face 108, and projected face 110. Projected face 110 is from where droplets are ejected from nozzles. Machined orifice plate 119 with machined nozzles 118 can give great precision to the sizing and geometry of, and conformity between, the nozzles. Polyimide or another bio-inert, mechanically stable polymer is preferable for the material of the orifice plate.

In some embodiments, the nozzles can be along a large face, such as the bottom face, in a “side shooter” configuration. In such a configuration, the microfluidic chip is largely on its side as a membrane is moved underneath.

On the bottom of microfluidic chip 102, conduit port hole 120 connects to etched conduit 126, which leads to pump chamber 128 (see FIG. 1B). Like the separation channels, etched conduits are not on the external surface but just underneath and visible in the figure through the transparent material of the bottom layer.

Pump chamber 128 has one side with a thin-walled inkjet diaphragm defined by its wall thickness, the thickness between external face 112 and an inner face of the pump chamber wall. The exemplary embodiment inkjet diaphragm has a thickness of 250 to 300 The precision can be ±50, ±25, ±10 or smaller. Ideally it should be less than 500 μm.

Piezoelectric actuator bar 130 is soldered to metal pads 131 on the outside of the inkjet diaphragm area and tight to the diaphragm. If using metal pads, they can extend beyond the actuator to enable electrical connection via wire, pin connector, or other method to an actuator circuit. In some embodiments, epoxy is used to bond the whole length of the piezoelectric actuator bar to the external face of the diaphragm. Another embodiment deposits a metal pad on the chip and then solders the actuator.

Microfluidic chip 102 is primarily made of glass that is compatible with electrophoresis of biomolecules. Optical requirements may include that it be transparent or translucent and be convenient to be able to look for bubbles/clogs under an inspection microscope.

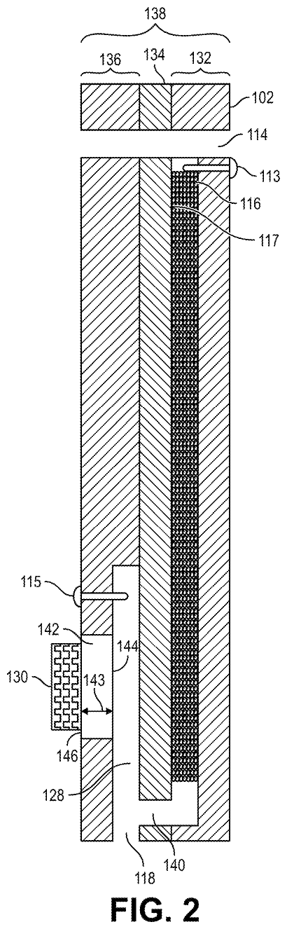

FIG. 2 is a cross section through microfluidic chip 102, the cross section being a slice through one of the separation channels 116. The vertical axis is expanded in order to see key features.

A sandwich 138 of layers 132, 134, and 136 makes up the system. That is, the layers are intimately disposed on one another. Layer 132 is the top layer, layer 134 is the middle layer, and layer 136 is the (bottom) pump layer. Top layer 132 and pump layer 136 sandwich middle layer 134 between them. Separation channel 116 is in top layer 132.

In the exemplary embodiment, separation channel 116 is filled with non-crosslinked sieving gel 117. The separation channel can include other sieving matrices, such as microbeads, nanoparticles, macromolecules, a colloidal crystal, other gels, a polymer solution, or one or more other media. Examples of gels suitable for use in a sieving matrix include those comprising acrylamide or agarose. The sieving gel can include, for example, one or more of sodium dodecyl sulfate (SDS), polyvinylpyrrolidone (PVP), polyethylene oxide (PEO), polylactic acid (PLA), polyethylene glycol (PEG), polydimethylacrylamide (PDMA), acrylamide, polyacrylamide, methylcellulose, hydroxypropylmethyl cellulose (HPMC), 30 hydroxypropyl cellulose (HPC), hydroxyethyl cellulose (HEC), agarose gel, or dextran.

At inlet end of separation channel 116 is electrode 113. Counterpart terminating electrode 115 is in pump chamber 128, common to all channels. In some embodiments, the terminating/ground electrode is located somewhere off the chip, such as in the buffer reservoir. The electrodes can be held at a voltage potential and assist in electrophoresis.

A sample can be electrokinetically injected by applying a high voltage, such as 150-500 V/cm for injection, for a particular amount of time (˜10-100 seconds). In the exemplary embodiment, all samples will use the same voltage and time; therefore, the electrodes do not have to be separate. After injection the remaining samples should be drained from the wells and replaced with separation buffer. In other embodiments, one, some, or all electrodes may be separate from the microchip.

Sample separation can require a high voltage electric field, for example 200-600 V/cm, for a particular amount of time (˜10 min). All separations can be conducted at the same voltage; therefore, the electrodes do not have to be separate.

Middle layer 134 has feedthrough hole 140 precisely positioned at the outlet end of separation channel 116. The feedthrough hole can be the same cross-sectional area as the separation channels or smaller, such as equivalent to a 50 μm diameter circle. In some embodiments, the cross-sectional area can be larger. The via/through hole middle layer is preferably thin to allow the proteins or other separated analyte to migrate quickly from the separation channel to the inkjet pump layer.

Pump layer 136 has pump chamber 128 etched within it. On the chamber's side are four nozzles 118, one of which is seen in the cross section. Nozzle 118 is aligned with and in the same cross section as its respective feedthrough hole 140.

On the bottom side of pump layer 136 is inkjet diaphragm 142. It is defined by wall thickness 143. That is, it is defined by a purposed section of constant or controlled wall thickness. Wall thickness 143 is the distance between external face 146 of pump layer 136 and internal surface 144 of chamber 128.

On the outside of inkjet diaphragm 142 is bonded piezoelectric bar actuator 130. Piezoelectric bar actuator 130 expands and contracts in response to electrical voltages, bending wall inkjet diaphragm 142. This movement can send acoustic waves through fluid in pump chamber 128.

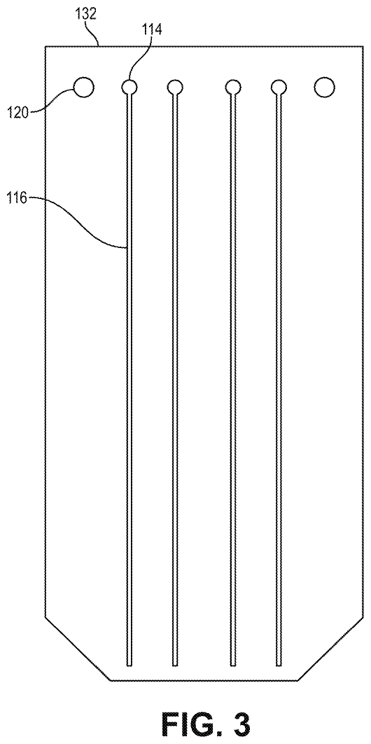

FIGS. 3-5 are plan views of the top layer, middle, and pump (bottom) layers, respectively, of a microfluidic chip.

FIG. 3 shows top layer 132. In top layer 132, port holes 114 extend from the inlet ends of separation channels 116 to an external face of the layer. Buffer fluid conduit port holes 120 are off to the side.

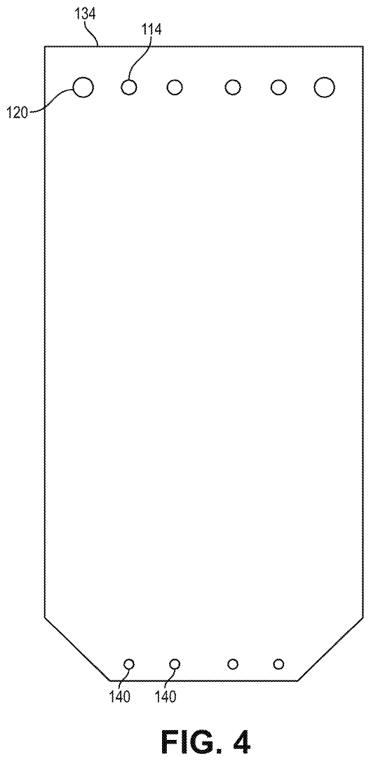

FIG. 4 shows middle layer 134. In middle layer 134, port holes 114 continue to extend therethrough. Similarly, buffer fluid conduit port holes 120 extend therethrough. Below the outlet end of each separation channel 116 (not shown in FIG. 4) is feedthrough hole 140. Feedthrough hole 140 fluidically (and electrically) connects the outlet end of separation capillary 114 to the pump chamber and its nozzle below.

In the exemplary embodiment, middle layer has a thickness between 1 μm and 300 μm.

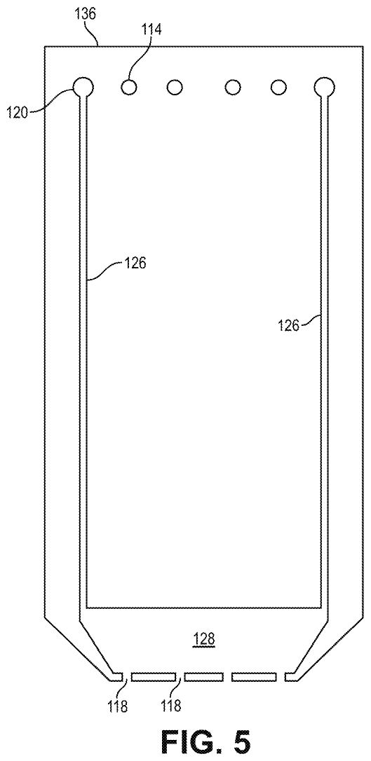

FIG. 5 illustrates pump layer 136. In pump layer 136, port holes 114 continue to extend therethrough such that port holes 114 are all of the way through the microfluidic chip.

Meanwhile, buffer fluid conduit port holes 120 lead from an external surface of pump layer 136 to conduit 126. Conduits 126 are connected with pump chamber 128. Pump chamber 128 spans laterally across all separation channel feedthrough holes (not shown in FIG. 5). Its inkjet diaphragm wall extends across all separation channels as well.

Nozzles 118 are formed on the side of pump chamber 128, each proximate the feedthrough hole from the middle layer and respective separation channel. Four of them are shown in the figure, corresponding to the four separation channels in the top layer. There may be fewer than four or many more.

In some embodiments, dozens, hundreds, or even thousands of separation channels can be paired with nozzles in a single microfluidic chip. A technical advantage is that only one relatively expensive part—a piezoelectric actuator—is needed to pulse the buffer fluid and eject separated analyte from the nozzles.

In order to get repeatable electrophoretic separation with minimal electroosmotic flow and analyte-wall interactions, the microfluidic chip may need to be conditioned prior to use. Conditioning includes loading and rinsing the separation channels with different reagents at a certain pressure and time duration. The reagents are typically 1M NaOH, water, 1M HCl, and a separation buffer. Electroosmotic flow suppression is achieved either by the separation buffer or by rinsing with a suitable static coating before the separation buffer is introduced (e.g., linear polyacrylamide, polyvinyl alcohol). Alternatively, the microfluidic chip can be permanently coated and only require separation buffer to be flushed through periodically.

Conditioning may occur in the instrument or externally in a ‘conditioning station’ (i.e., a separate device). It may be expected that a user will manually load the reagents to complete the conditioning process. It can also include automatic loading and/or draining controlled by a computer processor.

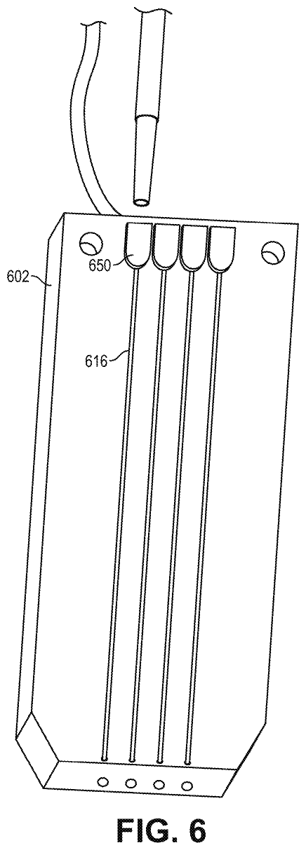

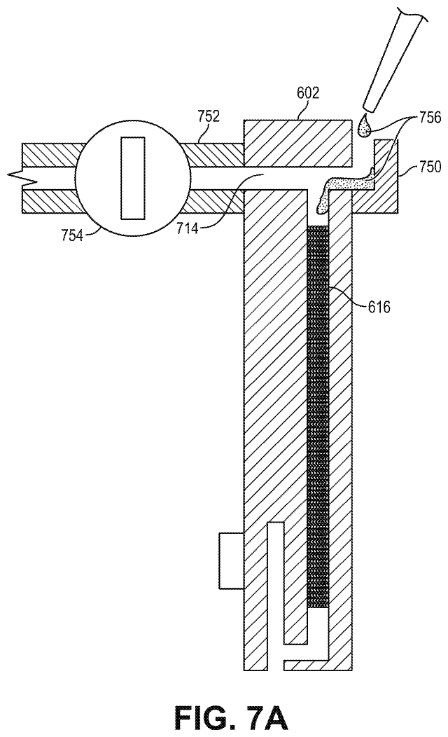

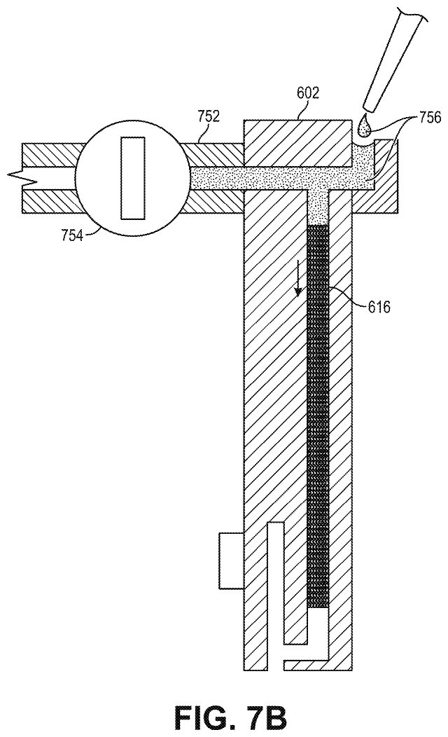

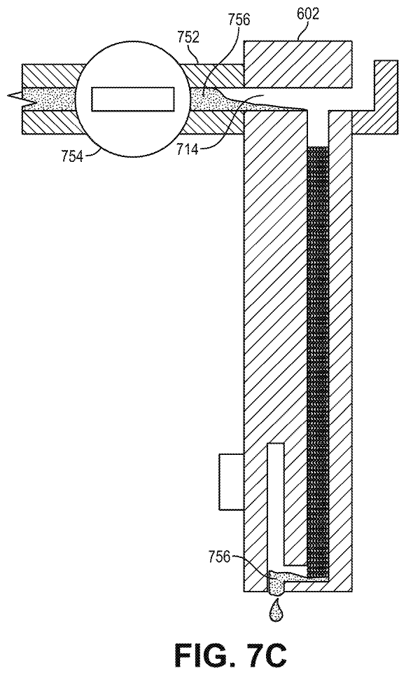

FIGS. 6 and 7A-7C illustrate cleaning blot printer chip 602 that is being prepared in accordance with an embodiment. Note that each separation channel port hole extends through the entire top, middle, and pump layers of the microfluidic chip.

FIG. 6 illustrates cups 650 creating cupped volumes on the external face around the port holes of separation channels 616. A pipette is centered over leftmost cup 650 in order to fill its cupped volume, the entrance to separation channel 616, and separation channel 616 itself, with fluid for purging and cleaning.

FIG. 7A illustrates purge connector 752 and purge valve 754 connected to port hole 714 of separation channel 616 on the pump side, bottom of the microfluidic chip. The purge valve is set to stop flow. On the opposite side of the chip, cup 750 catches cleaning/buffer fluid 756 from the pipette. Cleaning fluid 756 begins to flow into the cupped volume and entrance to separation channel 616.

FIG. 7B illustrates buffer fluid 756 stopping up against closed purge valve 754. This allows a user to exchange the fluid in port hole 714 without disturbing separation channel 616. In this way, the entrance can be cleansed.

A small amount of cleaning fluid, wanted or unwanted, may run through separation channel 616, although it may be held back or in place by capillary forces. Vacuum may be applied to the nozzle exits in order to more quickly clear out the fluid through the separation channels.

FIG. 7C illustrates purge valve 754 opened and cleaning fluid 756 flowing and exiting through. Traces of cleaning/buffer fluid may also drain out the nozzle bottom if pressure is applied or vacuum is applied to the nozzles. Vacuum may be applied to the purge valve connection in order to suction as much cleaning fluid as possible from the port hole 714. In this way, the microfluidic chip may be prepared for service or reused.

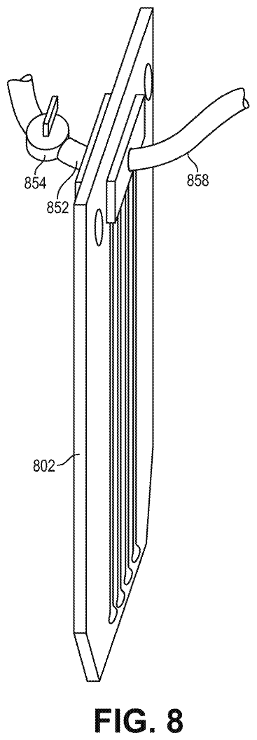

FIG. 8 illustrates pressurized manifold 858 for cleaning microfluidic chip 802 in accordance with an embodiment. Pressurized cleaning fluid is fed through manifold 858 into all the separation channel ports in microfluidic chip 802.

On the bottom of the microfluidic chip, purge valve 854 is connected by exit manifold 852 in order to catch fluid from all of the port holes.

When purge valve 854 is off, the fluid occupies the entrance area and the separation capillary, dribbling out the bottom. When purge valve 854 is turned on, excess fluid flows through it and out of the entrance. It can be subject to vacuum in order to drive most fluid out of the entrance.

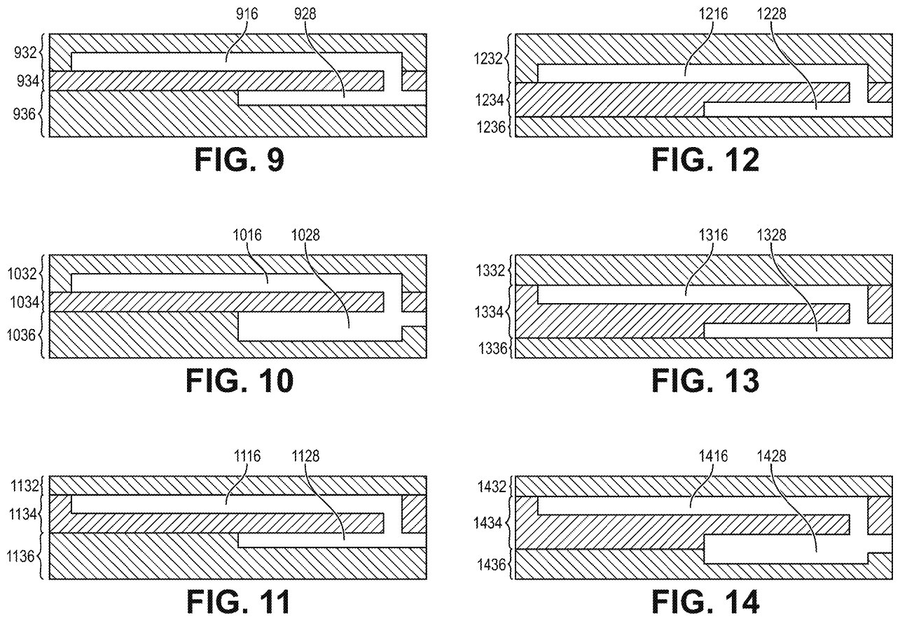

FIGS. 9-14 illustrate cross sections of various embodiments that show how different stratifications can be etched to create the top, middle, and (bottom) pump layers.

FIG. 9 illustrates a cross section of substrates similar to that in FIGS. 3-5. That is, separation channel 916 is etched in top substrate 932, and pump chamber 928 is etched in (bottom) pump substrate 936. Middle substrate 934 has a simple feedthrough hole.

FIG. 10 illustrates a cross section of substrates with a dug out pump chamber. While separation channel 1016 is etched in top substrate 1032 and middle substrate 1034 has a simple feedthrough hole, bottom substrate 1036 has a dug out area for pump chamber 1028. That is, the bottom of pump chamber 1028 is lower than the nozzles or other features.

FIG. 11 illustrates a cross section of substrates with a simple cap substrate 1132. Separation channel 1116 is etched in middle substrate 1134 along with a feedthrough hole. Pump chamber 1128 is etched in bottom substrate 1136.

FIG. 12 illustrates a cross section of substrates with a thick top substrate and pump chamber etched in the middle substrate. Separation channel 1216 is etched in top substrate 1232, and bottom substrate 1236 is a simple unetched cap substrate on the bottom. Middle substrate 1234 includes both a feedthrough hole and etched pump volume 1228.

FIG. 13 illustrates a cross section of substrates with separation and pump chamber volumes etched in a middle substrate. That is, both top substrate 1332 and bottom substrate 1336 are simple cap substrates. Meanwhile, relatively thick middle substrate is etched on one side with separation channels 1316 and on another side with pump chamber 1328.

FIG. 14 illustrates a cross section of substrates with a top cap substrate 1432 and a dug out pump chamber in a bottom substrate. It is similar to that of FIG. 13 with the difference that bottom substrate 1436 is etched to include a portion of pump chamber 1428. The other portion of pump chamber 1428 is etched in middle substrate 1434 while separation channels 1416 are etched on the other side of middle substrate 1434.

The middle layer substrate with the via/through hole between the separation channels and inkjet chamber may be glass, silicon, polyimide, SU-8, or other applicable materials. Preferred materials for the top and bottom layer substrate are glass, quartz, and silicon.

A “substrate” includes a physically distinct piece of typically homogeneous material, or as otherwise known in the art. A substrate may be bonded together with other substrates to form a chip.

A “layer” includes abstract slices of material regardless of initial substrates or workpieces, or as otherwise known in the art. For example, substrates 932, 934, 936, 1032, 1034, 1036, 1132, 1134, 1136, 1232, 1234, 1236, 1332, 1334, 1336, 1432, 1434, and 1436 shown herein may be themselves layers, or they may be abstractly divided differently into layers (e.g., with part of one substrate and part of another substrate in one layer).

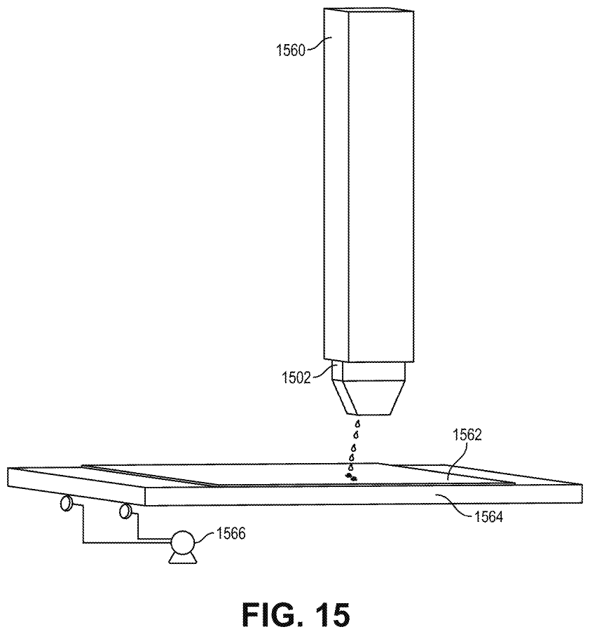

FIG. 15 illustrates a caddied blot printer chip held over a moving blotting membrane. Plastic caddy 1560 envelopes a portion of the top, middle, and pump layers of microfluidic chip 1502. It may simply protect the glass chip and/or have port connectors for ease of use. Traditional ports can be used that are either bonded to the chip or caddy. The nozzle portion of chip 1502 projects out of the bottom.

Blotting membrane support plate 1564 holds membrane 1562. Support plate 1564 is driven by motor 1566. It may be driven at a constant rate or at a variable speed. Variable speed may be useful in some embodiments as protein separation is an exponential/logarithmic process. In this fashion, output from the separation channels can be inkjetted along respective lines on the membrane and then analyzed.

The term “substantially” is used herein to modify a value, property, or degree and indicate a range that is within 70% of the absolute value, property, or degree. For example, an operation that occurs substantially entirely within a region can occur more than 70%, more than 75%, more than 80%, more than 85%, more than 90%, more than 95%, more than 96%, more than 97%, more than 98%, or more than 99% within the region. Similarly, two directions that are substantially identical can be more than 70%, more than 75%, more than 80%, more than 85%, more than 90%, more than 95%, more than 96%, more than 97%, more than 98%, or more than 99% identical.

The terms “about” and “approximately equal” are used herein to modify a numerical value and indicate a defined range around that value. If “X” is the value, “about X” or “approximately equal to X” generally indicates a value from 0.90X to 1.10X. Any reference to “about X” indicates at least the values X, 0.90X, 0.91X, 0.92X, 0.93X, 0.94X, 0.95X, 0.96X, 0.97X, 0.98X, 0.99X, 1.01X, 1.02X, 1.03X, 1.04X, 1.05X, 1.06X, 1.07X, 1.08X, 1.09X, and 1.10X. Thus, “about X” is intended to disclose, e.g., “0.98X.” When “about” is applied to the beginning of a numerical range, it applies to both ends of the range. Thus, “from about 6 to 8.5” is equivalent to “from about 6 to about 8.5.” When “about” is applied to the first value of a set of values, it applies to all values in that set. Thus, “about 7, 9, or 11%” is equivalent to “about 7%, about 9%, or about 11%.”

The terms “first” and “second” when used herein with reference to elements or properties are simply to more clearly distinguish the two elements or properties and unless stated otherwise are not intended to indicate order.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A microfluidic chip-based separation column and inkjet blotter apparatus comprising:
a top layer having multiple separation channels etched therein, each separation channel having an inlet end, an outlet end, and a port hole extending from the inlet end to an external face of the top layer;
a middle layer intimately disposed on the top layer, the middle layer having feedthrough holes, each feedthrough hole positioned at the outlet end of a corresponding separation channel;
a pump layer sandwiching the middle layer between the pump layer and the top layer, the pump layer having a chamber etched therein with nozzles on one side, each nozzle aligned with one of the feedthrough holes, the chamber sided by an inkjet diaphragm defined by a wall thickness between an external face of the pump layer and an internal surface of the chamber; and
a piezoelectric actuator bar bonded to the inkjet diaphragm, wherein the piezoelectric actuator bar spans across the multiple separation channels.

2. The apparatus of claim 1 wherein each separation channel port hole extends all the way through the top, middle, and pump layers.

3. The apparatus of claim 2 further comprising:
a purge valve connected with the at least one port hole.

4. The apparatus of claim 2 further comprising:
a cupped volume on the external face around at least one of the port holes.

5. The apparatus of claim 1 further comprising:
a machined orifice plate having the nozzles.

6. The apparatus of claim 1 wherein:
the top layer or the pump layer has a conduit etched therein that extends from a conduit port hole to the chamber, the conduit able to transport buffer liquid to the chamber.

7. The apparatus of claim 1 further comprising:
metal pads on the inkjet diaphragm, wherein the piezoelectric actuator bar is bonded to the inkjet diaphragm through solder to the metal pads.

8. The apparatus of claim 1 wherein the top layer and the pump layer are glass, quartz, or silicon, and the middle layer is glass and quartz, silicon or polyimide.

9. The apparatus of claim 1 further comprising:
a plastic caddy enveloping a portion of the top, middle, or pump layers.

10. The apparatus of claim 1 wherein the port holes are spaced apart 1.0 millimeter (mm), 2.0 mm, 2.25 mm, 4.5 mm, or 9.0 mm.

11. The apparatus of claim 1 wherein each separation channel has a straight section that is 20 millimeters (mm) to 100 mm long and a cross section of 500 square microns (μm²) to 5000 μm².

12. The apparatus of claim 1 wherein the inkjet diaphragm wall thickness is less than 500 microns (μm).

13. The apparatus of claim 12 wherein the inkjet diaphragm wall thickness is between 250 μm and 300 μm.

14. The apparatus of claim 1 wherein the middle layer has a thickness between 1 μm and 300 microns (μm).

15. The apparatus of claim 1 further comprising:
an electrode at the inlet end of each separation channel; and
an electrode in the chamber.

16. The apparatus of claim 1 further comprising:
a blotting membrane support; and
a motor configured to move the blotting membrane support relative to the nozzles.

17. A purgeable microfluidic chip-based separation column apparatus comprising:
a top layer having multiple separation channels etched therein, each separation channel having an inlet end, an outlet end, and a port hole extending from the inlet end to an external face of the top layer;
a middle layer intimately disposed on the top layer, the middle layer having feedthrough holes, each feedthrough hole positioned at the outlet end of a corresponding separation channel;
a pump layer sandwiching the middle layer between the pump layer and the top layer, the pump layer having a chamber etched therein with nozzles on one side, each nozzle aligned with one of the feedthrough holes, the chamber sided by an inkjet diaphragm defined by a wall thickness between an external face of the pump layer and an internal surface of the chamber; and
a piezoelectric actuator bar bonded to the inkjet diaphragm,
wherein each separation channel port hole extends all the way through the top, middle, and pump layers.

18. The apparatus of claim 17 further comprising:
a purge valve connected with the at least one port hole.

19. The apparatus of claim 17 further comprising:
a cupped volume on the external face around at least one of the port holes.

20. The apparatus of claim 17 further comprising:
a machined orifice plate having the nozzles.
